(19) United States
(12) Patent Application Publication
(10) Pub. No.: US 2006/0187236 A1
(43) Pub. Date: Aug. 24, 2006

(54) Control interface for converting subtractive color input to additive primary color output

(76) Inventors: Robert C. Runnels, San Carlos, CA (US); Joshua W. Garrett, San Francisco, CA (US)

Correspondence Address: COURTNEY STANIFORD & GREGORY LLP, P.O. BOX 9686, SAN JOSE, CA, 95157, US

(21) Appl. No.: 11/061,949

(22) Filed: Feb. 18, 2005

(51) Int. Cl. G09G 5/02

(52) U.S. Cl. 345/593

(57) ABSTRACT

A control interface for producing a composite color through the mixing of primary colors selected from a first color spectrum including red, yellow, and blue, resulting in the display of said composite color through a light array containing lights of a second primary color spectrum is disclosed. The user selects a color or colors from the first primary color spectrum, and a circuit and control algorithm controls the relative intensities of the colors comprising the second primary color spectrum, rendering the selected color or a mix of previously selected colors through the light array. Through the selection and graduated combination of the primary colors of the first spectrum, the creation of a wide range of colors in the visual spectrum is obtained for lighted color applications. When the first spectrum comprises the primary colors of red, yellow, and blue, the user is able to use the familiar three-primary, three-secondary color wheel, used in art education and taught in elementary school, for their color combination reference. The color selections from the first spectrum are coded to produce corresponding electrical signals to control the output of the light array to establish the proper mix of colors that displays the selected color.

### FIELD OF THE INVENTION

The present invention relates generally to light emitting diode arrays, and more specifically, to an interface for selecting input colors from a first color spectrum, whereby said colors or a mixture thereof can be displayed using a second color spectrum.

### BACKGROUND OF THE INVENTION

It is well known that mixing two colors together will result in the creation of a third color. There are two basic ways that colors can be mixed to make other colors, the additive and subtractive color mixing methods. In traditional color theory, which pertains to color that is created by mixing together colorants, such as paint, inks, and dyes, there are the three pigment colors, referred to as the primary colors, which cannot be mixed or formed by any combination of other colors. These colors are red, yellow, and blue (RYB). All other colors are derived from these three hues. The secondary colors of green, orange, and purple are formed by mixing the primary colors. The tertiary colors, yellow-orange, red-orange, red-purple, blue-purple, blue-green and yellow-green, are formed by mixing one primary and one secondary color. The combination of primary colors for pigments is referred to as subtractive color mixing because the light reflected from the mixture depends on the absorption (subtraction) of the first color and the second color.

The primary colors for light are different from the primary colors for paint. Mixing projected lights of different colors is referred to as additive color mixing because the combined colors are formed by the addition of light from one light source to the light from another light source. The primary colors for light are red, green, and blue (RGB). This additive primary color spectrum represents the least group of colors that can be used to generate the entire color spectrum, thus through additive color mixing, the different primary colors can be mixed to create other colors. By varying the relative intensity of the individual colored light sources, a full range of colors can be produced. Televisions, computer monitors, and electrical light displays all use the additive color process based on the primary RGB color wheel to create a full spectrum of color output. In the field of electronics, colored lights have long been made available through the use of light emitting diodes (LEDs). Until relatively recently, traditional LED colors were limited to red, amber, and green. With the successful development of blue LEDs, however, the trio of primary colors of red, green, and blue is now complete. Thus, LED arrays can be used to create a full range of colors that can be controlled through electrical circuits.

Children generally learn about colors through the use of media such as paints, crayons, and so on. Thus, they are taught about the primary color wheel in terms of pigments, rather than lights. Therefore, the red, yellow, and blue color palette represents the basic color of paints and pigments that is taught to children when they are first learning about color. Accordingly, the subtractive primary color spectrum of red, yellow, and blue is an intuitive spectrum when one thinks about mixing colors to produce other colors. For example, many people automatically think of producing green by mixing yellow and blue, producing orange by mixing red and yellow, and so on. Creation of colors by mixing the primary colors of the additive primary spectrum (red, green, blue) is not as intuitive for most people, because they were not taught about color mixing using light sources.

Although various products that produce colored light or have light emitting features can automatically generate the desired color based on a user selection of light by direct input, such products do not allow a user to mix colored lights using the subtractive primary spectrum of red/yellow/blue.

Therefore, what is desired is a system that allows a user to produce a full spectrum of colors in a light-emanating product using an input selection based on the red/yellow/blue primary color scheme.

What is further desired is a system that interfaces a color selection based on the red/yellow/blue subtractive primary colors to the red/green/blue additive primary colors suitable for use in light-emanating products.

### SUMMARY OF THE INVENTION

A control interface for producing a composite color through the mixing of primary colors selected from a first color spectrum including red, yellow, and blue, resulting in the display of said composite color through a light array containing lights of a second primary color spectrum is disclosed. A user selects a color or colors from the first primary color spectrum, and a circuit and control algorithm controls the relative intensities of the colors comprising the second primary color spectrum, rendering the selected color or a mix of previously selected colors through the light array. Through the selection and graduated combination of the primary colors of the first spectrum, the creation of a wide range of colors in the visual spectrum is obtained for lighted color applications. When the first spectrum comprises the primary colors of red, yellow, and blue, the user is able to use the familiar three-primary, three-secondary color wheel, used in art education and taught in elementary school, for their color combination reference. The color selections from the first spectrum are coded to produce corresponding electrical signals to control the output of the light array to establish the proper mix of colors that displays the selected color. The light array and control interface creates an intelligent, visually interactive interface for enhanced lighted-color applications.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1A is a block diagram of a circuit that interfaces a primary color selector to a tri-color LED array, according to one embodiment of the present invention;

FIG. 1B is a block diagram of a circuit that interfaces a primary color selector to a tri-color LED array, according to an alternative embodiment of the present invention;

FIG. 2A is a schematic of the electrical circuit for the tri-color selector and controller illustrated in FIG. 1A, according to one embodiment of the present invention;

FIG. 2B is a schematic of the electrical circuit for the tri-color selector and controller illustrated in FIG. 1B, according to one embodiment of the present invention;

FIG. 3A illustrates a configuration of a tri-color lamp style LED that can be used with embodiments of the present invention;

FIG. 3B illustrates a configuration of a surface-mount style LED that can be used with embodiments of the present invention;

FIG. 3C illustrates an electrical schematic for a tri-color LED that can be used with embodiments of the present invention;

FIG. 4 is a flowchart of the steps executed by a control circuit to interface a primary color input selection to one or more tri-color LED outputs, according to one embodiment of the present invention;

FIG. 5 illustrates a toy doll embodying a circuit interfacing an RYB input to one or more RGB tri-color LED outputs, according to one embodiment of the present invention; and

FIG. 6 illustrates a painting toy embodying a circuit interfacing an RYB input to one or more RGB tri-color LED outputs, according to one embodiment of the present invention.

### DETAILED DESCRIPTION OF THE PREFERRED EMBODIMENT

An interface for converting color input selected from a first primary color spectrum to output generated by a light array of a second primary color spectrum is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented by one or more computer or embedded microprocessor systems executing software instructions. According to one embodiment of the present invention, the steps of accessing, downloading, and manipulating the data, as well as other aspects of the present invention are implemented by one or more central processing units (CPU) executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be preloaded into the memory of the embedded system computer, or it may be loaded into memory from a storage device or from one or more other computer systems over a network connection. The processor may store instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software.

Many products employ lights to provide ornamental or functional features. For products such as electronic equipment, toys, and portable or battery powered goods, light-emitting diodes (LEDs) are often used because they are safe, cheap, and energy efficient. Because LEDs are available in a wide variety of colors, they are often used to provide a wide variety of functions, such as warning lights, ornamental colors, alphanumeric text display, and so on, for many different products. In one embodiment of the present invention, one or more LED devices are used to display a color on a product, or a portion of the product. A user selects a color to be displayed on the product by choosing a color or mix of colors from an input color spectrum. The user input can take a variety of forms, including but not limited to the selection of a color button, typing in the color selection, or similar means. The spectrum of colors available to be displayed on the product depends upon the color mix of the lights in the product. An electronic circuit within or coupled to the device can be used to translate the selected color to control the mixing of the lights to produce the desired color.

The advent of blue LED technology has allowed the display of a full spectrum of colors using tri-color LED arrays utilizing separate red, green, and blue (RGB) LED elements. Such LED arrays can be used in a wide variety of electronic lighting, instrumentation, and entertainment applications. The input interface to control the output colors of the LED array can be implemented in many different forms, depending upon the nature, function and purpose of the LED array. In one embodiment, the relative weighting of electrical values of LEDs within an array dictate which color is displayed by the individual LEDs or the combination of LEDs. The input interface translates a user's input choice with regard to the color to be displayed and causes associated circuitry to cause the selected color to be displayed through the LED array. The input interface also allows for the graduated mixing of colors, such that a displayed color can be modified by “adding” or “subtracting” a color or combination of colors from the input color spectrum.

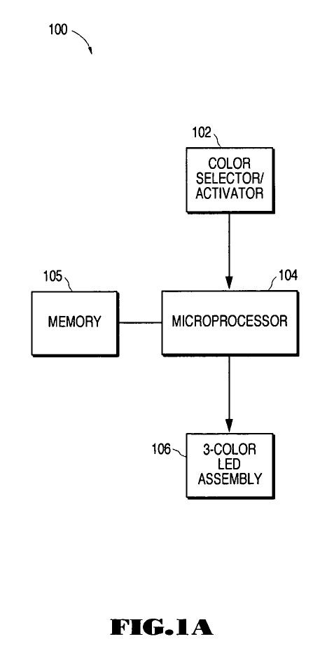

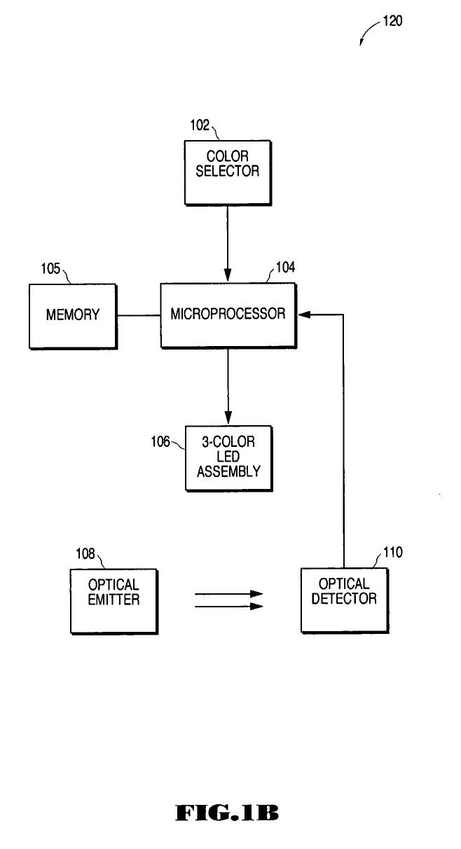

FIG. 1A is a block diagram that illustrates the components for an electronic interface circuit for interfacing a primary color selector to a tri-color LED array, according to one embodiment of the present invention. In system 100, a color selector/activator circuit 102 is coupled to a microprocessor 104. The color selector is an input device that is operated by a user to select the color to be added to or displayed by the tri-color LED assembly 106 and cause the selected color to be transmitted to the microprocessor 104. The microprocessor 104 receives the color selection from the color selector 102 and communicates the appropriate signals to the LED assembly 106 to cause a display of light, thereby transmitting the selected color. A memory circuit 105, coupled to microprocessor 104, stores the instructions required to interface the user input color selector to the LED assembly output.

FIG. 1B is a block diagram that illustrates the components for an electronic interface circuit for interfacing a primary color selector to a tri-color LED array, according to an alternative embodiment of the present invention. In system 120, the system comprising the color selector 102, microprocessor 104, tri-color LED assembly 106, and memory 105 are identical to the system shown in FIG. 1A, except that circuit 120 includes an optical emitter 108 and an optical detector 110, and the color selector 102 does not transmit the color choice to the microprocessor. The optical detector 110 is located within the object and controls the output of the LED assembly that is located within the object. The optical emitter 108 is used to transmit the selected color to the optical detector 110.

In one embodiment of the present invention, the color selection circuit 100 or 120 is used in an object, such as a toy, art product or ornamental device, to allow the user to select a color from a color palette or similar selection mechanism and mix that color into the existing color displayed on a portion of the object. For example, if the object is a toy, such as a doll or car, a child can use the circuit to change some of the colors of the toy. One or more LED assemblies are mounted or embedded within specific areas of the toy for illumination. For the embodiment illustrated in FIG. 1B, the toy includes an optical emitter 108 and an optical detector 110 located within the toy that alters the colors displayed on the LED assembly that is located within the toy. The user selects an input color and “transfers” this color to the toy by placing the emitter close to the detector. Based on the color selected and the color, if any, already being displayed by the LED assembly 106, a new color is calculated by the microprocessor 104 and displayed by the LED assembly. For different LED assemblies within the product, each LED assembly that can be separately lighted is associated with a separate optical detector. The optical emitter can be embodied within a pen or brush type of element to “transfer” the color from a color selection palette to the region of the toy to be colored.

In an alternative embodiment, the optical detector circuit 110 of FIG. 1B receives the color selected by the user directly from the color selector 102. In this case, the optical emitter does not transfer the identity of the selected color to optical detector 110, but instead only triggers the incorporation of that color. For this embodiment, the switches or other input mechanism directly control the color selection provided to the optical detector for output by the LED assembly 106.

In one embodiment of the present invention, the color selector 102 comprises a color palette that provides the user with a selection of the three pigment-based primary colors of red, yellow, and blue. The user can “mix” these colors by first selecting one color, applying it to an appropriate area of the product, then selecting a second color and applying it to the same area of the product. The applied color can be modified by adding more red, yellow, or blue from the palette. The microprocessor 104 decodes the added color components and causes the LED assembly to change colors accordingly. For this embodiment, the LED array is a tri-color LED device comprising red, green, and blue light emitting diode elements. Thus, the circuits of FIGS. 1A and 1B both transform the user input provided from an RYB color palette to colors produced by an RGB light array.

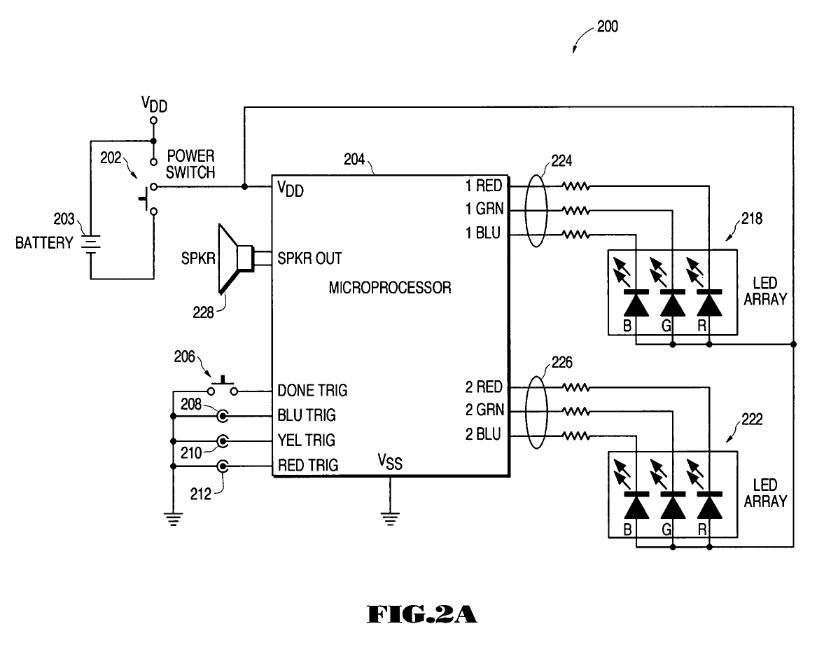

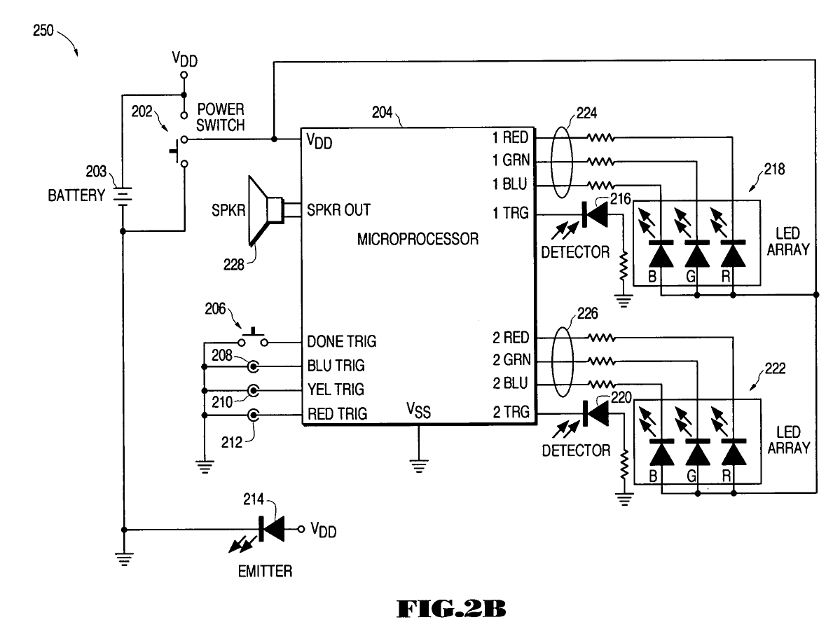

FIG. 2A is a schematic of the electrical circuit for the tri-color selector and controller illustrated in FIG. 1A, according to one embodiment of the present invention. A microprocessor 204 interfaces color selection input signals provided by the user to produce an appropriate output through one or more LED arrays located in or on the surface of an object. For self-contained products, a battery 203 provides power to the circuit and power switch 202 controls application of the power, V_{DD}. The color selector for input of the colors is provided by switches 208, 210, and 212. For circuit 200, the colors available to be selected by the user are red, yellow, and blue. One switch is provided for each input color, thus switch 208 provides the blue input, switch 210 provides the yellow input, and switch 212 provides the red input. These switches produce trigger signals for their respective color selections. The color input selection switches 208, 210, and 212 can be embodied within any type of user selectable switch, including but not limited to a contact pad, toggle switch, dial, touch-button screen, motion detector, voice recognition system, and so on. Though not necessary, a “done” switch 206 and speaker 228 can also be included to signal the end of a color input selection.

The number of times that a color activation switch is triggered, or the duration of time that the switch is activated is used by the microprocessor as a relative weighting value for that particular color. Other methods of controlling the relative weighting value of the selected color, such as the use of a dial, are also possible.

FIG. 2B is a schematic of the electrical circuit for the tri-color selector and controller illustrated in FIG. 1B, according to one embodiment of the present invention. The circuit 250 illustrated in FIG. 2B is substantially identical to that of circuit 200 illustrated in FIG. 2A with the addition of the emitter and detector elements shown in FIG. 1B. Thus, in circuit 250, the application of a chosen color is triggered by emitter 214. In one embodiment, the emitter 214 is an infrared emitter that is embodied within a stylus or wand that can be used to touch or point to a particular region of the object to be colored.

Any number of regions within the object can contain tri-color LED arrays. Two such LED arrays are illustrated in FIG. 2 as arrays 218 and 222. Each region of the product to be lighted and colored contains at least one LED array and in some embodiments an associated infrared detector. For the exemplary circuits shown in FIGS. 2A and 2B, two sets of LED arrays and detectors are shown. The first region (region 1) is controlled by signal lines 224. In the emitter/detector embodiment of circuit 250, the detector 216 detects the user selected color being transmitted by emitter 214. The microprocessor then outputs the appropriate signals on the respective red/green/blue signal lines 224 to cause the LED array to light in the selected color or to incorporate the selected color into the color already being displayed by the LED array. Similarly, when the emitter 214 is placed in range of detector 220, the LED array 222 in region 2 will light in accordance with the signals' output on control lines 226.

Depending on the type of microprocessor used and the design of the control circuit, a large number of different regions of the object can be lighted. In one embodiment, microprocessor 204 is an 8-bit microprocessor. Various types of microprocessor devices can be used depending upon the resources available, application, and degree of color resolution required. The circuits illustrated in FIGS. 2A and 2B are intended to be simplified examples of a microprocessor control circuit that can be used to implement an embodiment of the present invention. For example, throughout circuits 200 and 250, various current limiting resistors are shown, for which the appropriate values should be determined empirically as understood by those of ordinary skill in the art.

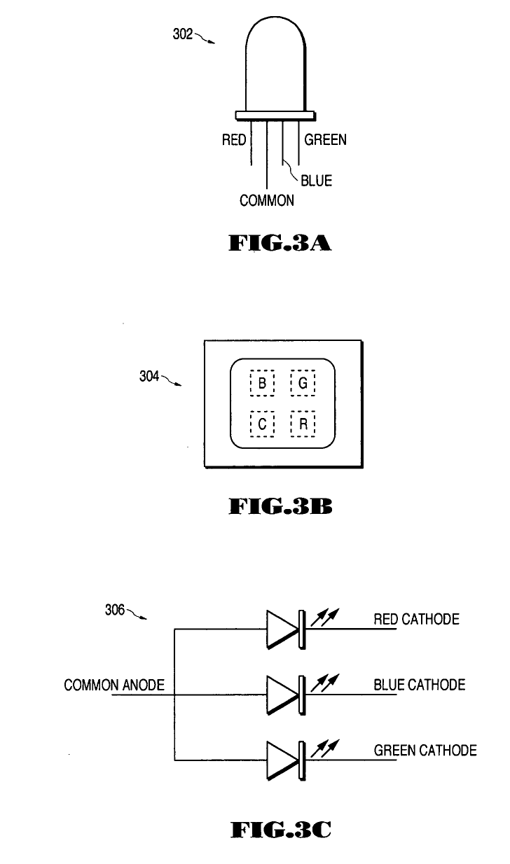

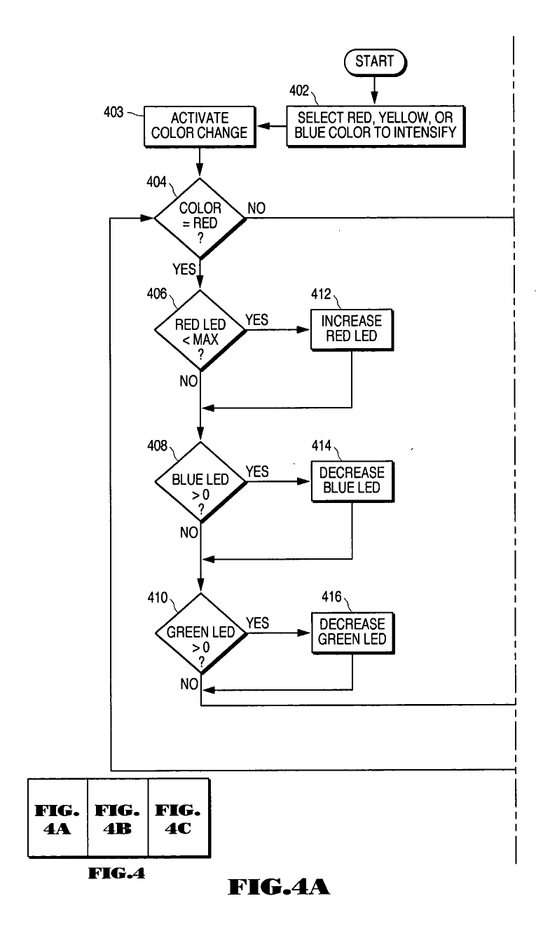

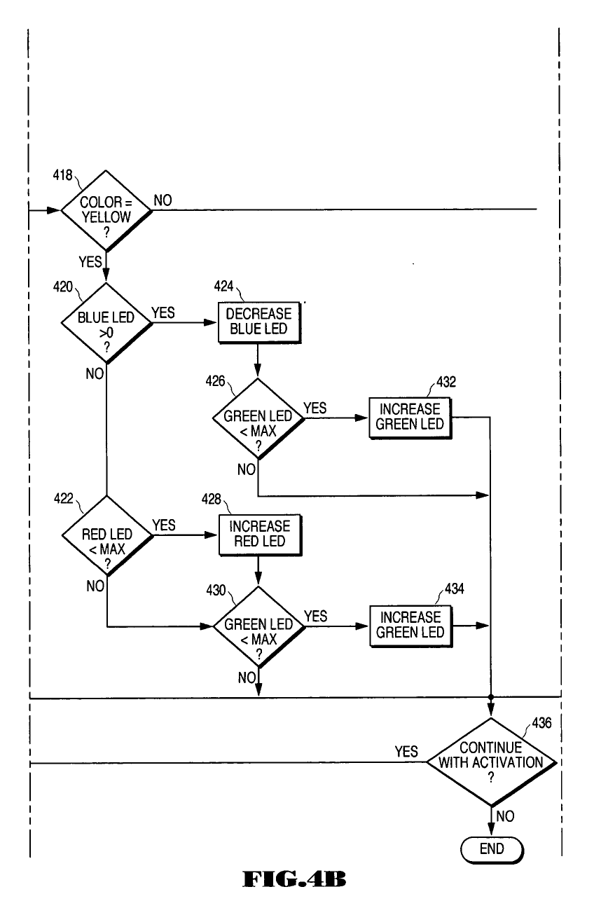

For the embodiments of circuits 200 and 250, one or more LED arrays is used to light various regions of an object. Each LED array is comprised of separate red, green, and blue light-emitting diode elements. These diodes can be embodied within separate devices or packaged as a single array. FIG. 3A illustrates a configuration of a tri-color lamp style LED that can be used with embodiments of the present invention. For LED array 302, the three separate light elements are housed within a single plastic or resin housing. Electrical leads are then provided for each of the elements, including the red LED cathode, green LED cathode, blue LED cathode, and the common anode. FIG. 3B illustrates an alternative type of tri-color LED device. LED array 304 is an example of a surface-mount LED array that contains four surface mount pads for the three RGB cathode leads and the common anode. LEDs such as those illustrated in FIGS. 3A and 3B are generally available from a number of manufacturers, such as Nichia® Corporation. Any similar type of tri-color LED device can be used, depending upon the configuration of the object, and FIG. 3C is a schematic representation of the tri-color LED array to be used. Typically the LED array or arrays will be mounted on the surface of the object, or just beneath the surface of the object if the cover material is sufficiently transparent to allow the colored light to be visible.

In one embodiment of the present invention, the LED array or arrays are electronically controlled through Pulse Width Modulation (PWM) to produce the proper mixture of colors. By varying the electrical power to each of the LEDs within the array, the color output and intensity of the LED array can be varied to produce the color desired. In pulse width modulation, the output and intensity of an LED is controlled by altering the duty cycle of a square wave switching between 0 volts and the supply voltage that is inputted as a trigger signal to the LED. For this embodiment, microprocessor 204 generates a square wave output on LED array trigger lines 224 and 226. The color selected by the user determines the duty cycle of the square wave and is stored in a register within the microprocessor. One register is available for each output color (RGB) within each region.

In general, the user will select a first color to apply to a region, e.g., region 1, of the product. For example, the user may select region 1 to initially be yellow by activating switch 210 and applying this color to region 1 by moving emitter 214 to detector 216. The microprocessor will then cause the appropriate square wave pulses to send the appropriate trigger signal over the RGB trigger lines 224 to light the LED 218 array in a yellow color. If the user desires to make the color more orange, he or she can add red by selecting the red switch 212 and using the emitter 214 to “apply” red to region 1. The microprocessor will then alter the square wave output to trigger the appropriate RGB trigger signals to cause the LEDs to produce more of an orange hue in region 1.

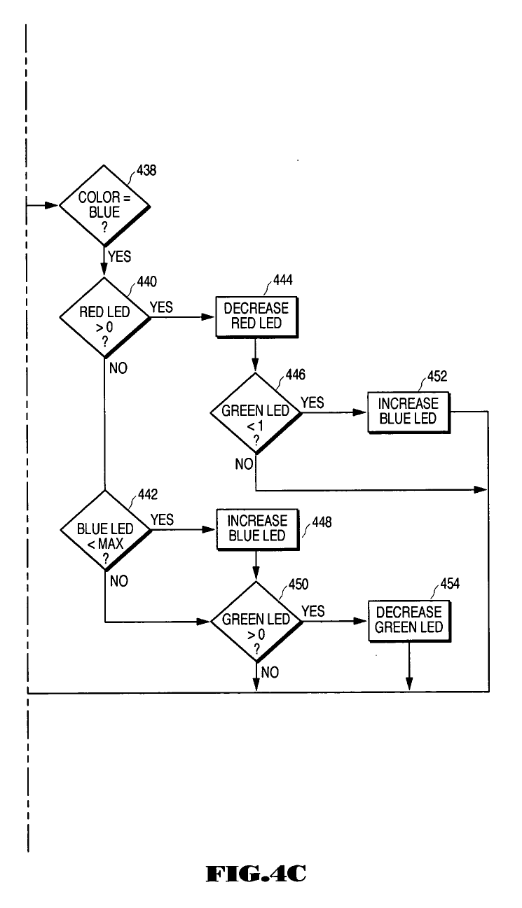

As illustrated in FIGS. 2A and 2B, control of the interface between the color selected by the user and the color displayed through the LED arrays is provided by a microprocessor, or similar type of logic circuit. The microprocessor executes a program that senses and stores the user inputs and translates these inputs into LED control signals. FIG. 4 is a flowchart that illustrates the steps executed by the microprocessor or logic circuit to interface a primary color input selection to one or more tri-color LED outputs, according to one embodiment of the present invention.

In step 402, the user selects one color of the primary color palette, red, yellow or blue, which he or she wishes to add to a region or intensify within the region. In one embodiment this is performed by activating a switch that indicates the color to be selected or intensified. In response, the circuit activates a color change. In steps 404, 418, and 438, the circuit determines whether the selected color is red, yellow, or blue, respectively. If in step 404, it is determined that the selected color is red, the circuit determines whether the red value is at maximum. If the red value is not at maximum, the red signal value is increased, step 412. The circuit then determines whether the blue light value is greater than zero, step 408. If it is, the blue signal value is decreased, step 414. The circuit then performs the same operation for the green light value, step 410. If the green signal value is greater than zero, the green signal value is decreased, step 416. The circuit then determines whether the color change activation should be continued, step 436. If not, the process ends; otherwise the process continues to determine which additional color is selected.

If the selected color is yellow as determined in step 418, the circuit determines whether the blue signal value is greater than zero, step 420. If yes, the blue signal value is decreased, step 424. The circuit next determines whether the green signal value is less than the maximum, step 426. If so, the green signal value is increased, step 432, and the system then continues with additional color changes, step 436. If not, the system continues directly to step 436. If, in step 420 it is determined that the blue color value is not greater than zero, the circuit then determines whether the red color value is less than maximum, step 422. If so, then the red signal value is increased, step 428. The circuit then determines whether the green signal value is less than maximum, step 430. If so, the circuit increases the green signal value, step 434, and then continues with step 436. If not, the process continues by determining whether there are additional color changes, step 436. If, at step 422, the red signal value is at its maximum, then the system continues to step 430.

If the selected color is blue as determined in step 438, the circuit determines whether the red signal value is greater than zero, step 440. If yes, the red signal value is decreased, step 444. The circuit next determines whether the green signal value is less than one, step 446. If so, the blue signal value is increased, step 452, and the system then continues with additional color changes, step 436. If not, the system continues directly to step 436. If in step 440 it is determined that the red color value is not greater than zero, the circuit then determines whether the blue color value is less than maximum, step 442. If so, then the blue signal value is increased, step 448. The circuit then determines whether the green signal value is greater than zero, step 450. If so, the circuit decreases the green signal value, step 454, and then continues with step 436. If not, the process continues by determining whether there are additional color changes, step 436. If, at step 442, it is determined that the blue signal value is not less than maximum, the system continues to step 450.

As shown in FIG. 4, the illustrated process receives as inputs the relative intensity of red, yellow, and blue color selections, and produces the resultant output color through a red, green, blue tri-color LED array. The decrease or increase in the relative light values for the three LEDs is modified to increase or decrease their respective output strength. This color weighting among the three LEDs can produce a wide variety of colors virtually across the entire spectrum.

For the process illustrated in FIG. 4, the light signals are assigned a weighting value between 0 and a certain maximum value. The weight that a particular color is assigned depends on the user input provided to the respective color input switch. This could be measured, for example, by the number of discrete switch activation cycles or the duration of time that a switch is activated. The invention may incorporate other means of determining the weighting value, including but not limited to a dial or other interface with multiple settings allowing for a graduated increase in intensity. For example, for the embodiment represented by the circuit in FIG. 2A, a user may choose to intensify the blue color by pressing the blue switch 208 a certain number of times or by holding it down for a period of time.

The embodiment illustrated with respect to the flowchart of FIG. 4 described a system in which the color mixing was performed by modifying the LED array output to add the color selected by the user. In an alternative embodiment, the system can be configured to subtract the primary color selected by the user. Thus, if the user selects yellow, the circuit causes the LED array to decrease, rather than increase, the intensity of the yellow color component of the color mix. In another embodiment, the system can modify the LED array output to add more than one color at a time, based on the user's selection of more than one color simultaneously. Thus, if the user selects both yellow and red at the same time, the circuit modifies the LED array output to display more orange.

In an alternative embodiment, the user can select more than one color from the palette as a “pre-mixed color” prior to application and display on the LED array. In this case, the color mixture is displayed on an LED array that is typically in a neutral state, although it may also be already displaying some color. In a neutral state, the LED array is typically in an off or deactivated state. In this state, the LED array may not project light at all and can appear dark or clear. Alternatively, the neutral state of the LED may project a color that is interpreted as “white” by the human eye. For the embodiment in which the pre-mixed color is applied to a neutral LED array, rather than adding to or subtracting from a color already being projected by the LED array, the array displays a composite color derived solely from a series of color selections made by the user prior to application to the array. Using more selections of one color relative to another, or through a selection of different weighting values, a user could alter the relative intensities of the colors comprising the composite color to be displayed. In one embodiment, for example, the user could, with several selections of red and one selection of yellow, display a reddish orange color on a neutral LED array.

The circuit illustrated in FIGS. 1 and 2 can be implemented in virtually any type of object that can accommodate user selectable colors along its surface. Because the interface translates the primary colors of red, yellow, and blue into different resultant colors, it is especially well suited for use in children's toys, since children first learn about colors through this primary color spectrum. Thus, embodiments of the present invention can be directed to toys in which the color input selection is provided through a palette of the three colors red/yellow/blue. Art products or similar ornamental items with color selectable features are another useful application of the invention.

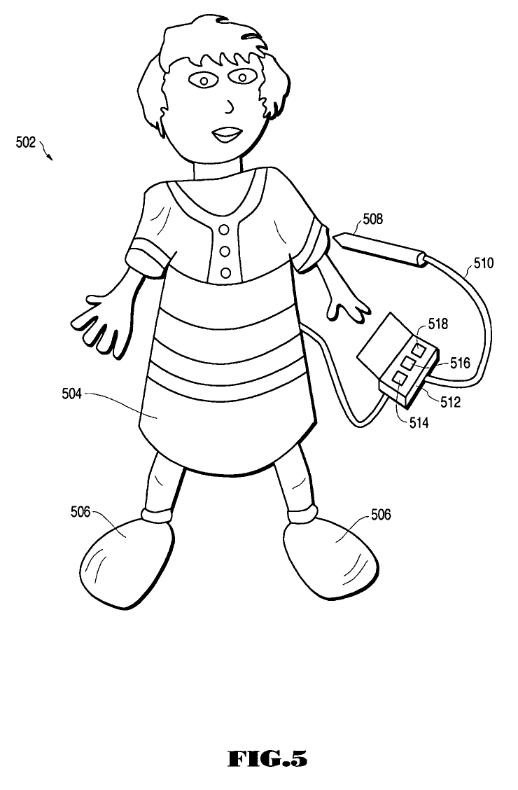

FIG. 5 illustrates a toy doll that incorporates embodiments of the present invention. The toy includes several areas that contain tri-color LED assemblies, which can be used to display light of any color of the spectrum. Thus, the doll 502 includes one or more areas that a child can select to alter the color of the doll. The color controllable areas can include the doll's dress 504 and shoes 506. Each color selectable area contains one or more tri-color LED arrays, such as those illustrated in FIG. 3A or 3B, as well as an infrared detector. A circuit, such as circuit 100 is embedded within the doll and translates the color input selection provided by the child to an output produced by the LED arrays.

The input color switches are provided in a primary color spectrum palette 512. Three color buttons or pads are provided 514, 516, and 518, each for one of the primary colors of red, yellow, and blue. A wand or stylus 508 is used to apply the different colors to the color-selectable regions or items of clothing of the doll. The wand 508 includes an infrared emitter. The child selects the color to be applied or intensified within the color mix by bringing the wand close to the desired color switch in the color palette case. The color selection is stored by the logic circuit. When the wand is brought into the proximity of the area to be colored, the detector picks up the wand's infrared signal and this is treated as a color activation switch. The logic circuit then performs the process steps illustrated in FIG. 4 to produce the appropriate light output through the tri-color LED array or arrays. The detectors can be configured such that either a discrete number of approaches by the wand increases the color value or keeping the wand near the detector for a number of seconds increases the color value. Both configurations can be active concurrently as well.

In one embodiment of the present invention, the switches 514, 516, and 518 are tactile switches that register their selection to the microprocessor. In an alternative embodiment, the switches themselves can be embodied as color samples or color chips. In this case, the emitter 508 includes an optical detector that detects the color selected when the user places the wand over the color on the palette. In this case, the microprocessor stores the color value detected by the emitter wand 508.

As can be appreciated by those of ordinary skill in the art, other areas of the doll can also be lighted and controlled, such as the doll's hair, fingernails, skin, and so on.

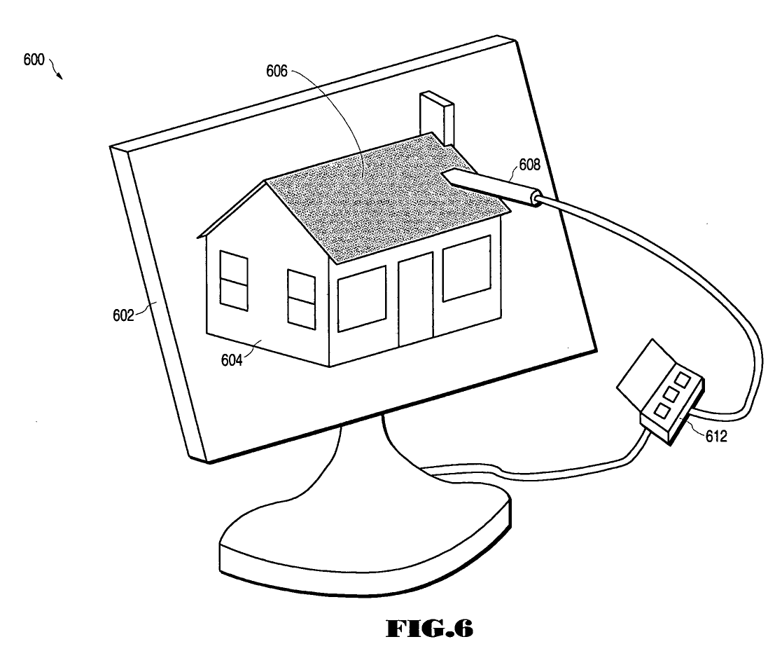

Any number of different toys or ornamental items can implement embodiments of the present invention. For example, FIG. 6 illustrates an art product that allows a picture or displayed item to be “painted” using a simulated paintbrush, crayon, or similar coloring device 608. The surface of an easel 602 can include the tri-color LED arrays and infrared detectors and displays a picture of an object, such as a house that can be painted in different colors. The control circuit 100 is embedded within the product and the primary RYB color switches are provided on a palette 612. The color to be applied to the displayed picture is applied using brush or wand 608. Different areas of the displayed picture, such as the wall 604 or roof 606 of the house, can be painted different colors by applying the selected color to these regions. Borders or outlines defined within the picture limit the application of a selected color to specific regions so that specific items, such as the roof, door, windows, walls, and so on can be colored differently.

The first color spectrum described with respect to embodiments of the present invention comprises the primary subtractive color spectrum consisting of red, yellow, and blue. Alternatively, the subtractive color spectrum of cyan, magenta, and yellow, or any other spectrum of base colors that can be mixed to produce other colors can be used. For this alternative embodiment, the color selection palette would consist of switches or color chips representing these colors.

Although specific circuit elements and program steps have been described in conjunction with embodiments of the present invention, it should be noted that variations known by those of ordinary skill in the art can be used instead of, or in combination with the specifically cited structures and methods. For example, the described embodiments include the use of LEDs as the light elements, however, other types of colored lights can also be used, such as low intensity lamps, gas discharge lights, incandescent colored lights, and other light-emanating devices that are heretofore unknown. By way of example and not limitation, the selector switch 102 can be embodied in an alphanumeric text input mechanism, a mechanical push-button switch arrangement, a voice recognition system or a motion detector.

In the foregoing, a system has been described for an interface between a primary color input selector and a tri-color LED array output. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A system for controlling the color output of a product, the system comprising:
a selector circuit providing a selection of colors from a first spectrum of colors comprising the colors red, yellow, and blue;
a light array comprising a second spectrum of colors linked to the controller circuit;
a controller circuit that configures the light array to display a color that reflects the mixing of one or more colors selected from the first spectrum with any color displayed by the light array prior to such selection.

2. The system of claim 1 wherein the light array comprises a tri-color light emitting diode (LED) array.

3. The system of claim 2 further comprising a microprocessor coupled to the selector circuit and light array, and configured to control the light array through pulse width modulation.

4. The system of claim 3 wherein the microprocessor is programmed to display a first color selected by the selector circuit on the light array and add a color component of a second color selected by the selector circuit on the light array.

5. A system for controlling the color output of a product, the system comprising:
a selector circuit providing a selection of colors from a first spectrum of colors comprising the colors red, yellow, and blue;
a light array comprising a second spectrum linked to the controller circuit;
a controller circuit that configures the light array to display a color that reflects the complete or partial removal of the color selected from the first spectrum from any color displayed by the light array prior to such selection.

6. The system of claim 5 wherein the light array comprises a tri-color light emitting diode (LED) array.

7. The system of claim 6 further comprising a microprocessor coupled to the selector circuit and light array, and configured to control the light array through pulse width modulation.

8. A system for controlling the color output of a product, the system comprising:
a selector circuit providing a selection of colors from a first spectrum of colors comprising the colors red, yellow, and blue;
a light array in a neutral state, wherein the light array is configured to display colors derived from a second spectrum of colors when placed in an activated state; and
a controller circuit that configures the light array to display a color that reflects a mixing of one or more colors selected from the first spectrum of colors.

9. The system of claim 8 wherein the light array comprises a tri-color light emitting diode (LED) array.

10. The system of claim 9 further comprising a microprocessor coupled to the selector circuit and light array, and configured to control the light array through pulse width modulation.

11. A method of interfacing a color selector to a light array, comprising the steps of:
receiving a first color selection from a palette containing an option of red, yellow, or blue color input;
determining whether the first color selection is red, yellow, or blue;
generating the relative intensity values of a light array comprising a red light element, a blue light element, and a green light element in order to produce the first selected color on the light array, the first selected color producing a red light value, a blue light value, and a green light value, the light values corresponding to relative intensities of the light elements;
receiving a second color selection from the palette;
altering the relative light values of the light array to add the color component corresponding to the second color selection for display on the light array.

12. The method of claim 11 wherein, if the first or second color selection is red, the method further comprises the step of determining whether the red light value is less than maximum, and if so, increasing the red light value; then decreasing the blue light value if the blue light value is greater than zero, and then decreasing the green light value if the green light value is greater than zero.

13. The method of claim 12 wherein, if the first or second color selection is yellow, the method further comprises the step of determining whether the blue light value is greater than zero, and if so decreasing the blue light value and increasing the green light value if the green light value is less than maximum; and if not, increasing the red light value if the red light value is less than maximum, then increasing the green light value if the green light value is less than maximum.

14. The method of claim 13 wherein, if the first or second color selection is blue, the method further comprises the step of determining whether the red light value is greater than zero, and if so decreasing the red light value and increasing the blue light value if the green light value is less than one; and if not, increasing the blue light value if the blue light value is less than maximum, then decreasing the green light value if the green light value is greater than zero.
